(19) United States
(12) Patent Application Publication
(10) Pub. No.: US 2013/0062169 A1
(43) Pub. Date: Mar. 14, 2013

(54) COVER FOR INNER CONVEYOR OF TELESCOPIC ASSEMBLY

(71) Applicant: Thor JOHANNSEN, Ontario (CA)

(72) Inventor: Thor JOHANNSEN, Ontario (CA)

(73) Assignee: Thor Global Enterprises Ltd., Ontario (CA)

(21) Appl. No.: 13/438,471

(22) Filed: Apr. 3, 2012

(30) Foreign Application Priority Data
Sep. 12, 2011 (CA) 2751969

(51) Int. Cl. B65G 21/08

(52) U.S. Cl. 198/860.5

(57) ABSTRACT

A telescopic conveyor having at least first and second conveyor sections in which a first one of the conveyor sections is retractable and telescopes into at least one other conveyor section, the improvement wherein the first one of conveyor sections includes a protective cover therefore covering the top of the first one of the first conveyor sections when the first one of the conveyor sections is in an extended position from the other conveyor section.

### PRIORITY

This application claims priority under 35 U.S.C. §119(a) to a Canadian Patent Application filed in the Canadian Patent Office on Sep. 9, 2011 and assigned Ser. No. 2,751,969, the entire disclosure of which is incorporated herein by reference.

### BACKGROUND OF THE INVENTION

1. Field of Invention This invention relates generally to telescopic conveyor assembly and more particularly to a protective cover for an inner conveyor of a telescopic conveyor assembly.

2. Description of the Related Art There are several known examples of conveyor systems, particularly telescopic systems, as disclosed, for example, in U.S. Pat. No. 6,056,252, titled “Support Assembly For Telescopic Conveyor System,” issued May 2, 2000 to Johannsen, for a typical conveyor system. Telescopic conveyor systems are commonly used to transport materials from one location to another location. Typically, telescopic conveyor systems have a frame which includes an elongate extendable frame mounted for reciprocal movement on an elongate base frame. Reciprocal movement of the extendable frame is usually facilitated by a number of rollers which are mounted directly on either the base frame or the extendable frame and which travel along guide tracks.

In recent years, mobile telescopic conveyor belts have seen use in very heavy industries such as the aggregate industry where mobile conveyors are used to construct non-segregated stock piles of aggregate materials. Telescopic conveyor belts used in the aggregate industry are generally larger than those described in the above mentioned patents, and have an elongate base frame with a rectangular cross-section which telescopically receives an elongate extendable section having a smaller rectangular cross-section. By way of example, the Thor Aggregate Equipment Division of Thor Steel And Welding Ltd. of Mississauga, Ontario, Canada produces and sells a telescopic conveyor system for use in the aggregate industry known as a Telescopic Portable Radial Stacker which, in one version, has a retracted length of approximately 82.5 feet and an extended length of approximately 136 feet. In order to adequately support the extendable frame, a number of parallel, spaced support rollers are typically located at the bottom side of the outward end of the base frame for engaging the underside of the extendable frame, and a number of parallel, spaced support rollers are located at the top side of the base frame, some distance from the outward end of the base frame, for engaging the top-side of the extendable frame. In the past, these support rollers have all been mounted on the base frame independent of each other.

Depending on the use and application of the telescopic conveyor system it is becoming desirable to provide a cover system for the inner conveyor assembly when it is extended for use. A cover system such as that proposed by the present invention, would provide protection for the inner conveyor assembly when in use and thus prevent weather such as rain, snow, etc. from damaging or coming in contact with the material being transported by the conveyor of the inner conveyor system.

The present invention provides a novel arrangement for applying a protective cover to the inner conveyor system assembly, which protective cover system can be utilized in a retracted position for storage when the inner conveyor assembly is retracted into the outer conveyor assembly in a telescopic manner and at the same time the protective cover can be readily extended when the inner conveyor system is in a use position.

### SUMMARY OF THE INVENTION

Accordingly, the present invention has been made to solve the above-stated problems occurring in the prior art, and the present invention provides a protective cover for an inner conveyor of a telescopic conveyor assembly.

According to an aspect of the present invention, there is provided a telescopic conveyor having at least first and second conveyor sections in which a first one of the conveyor sections is retractable and telescopes into at least one other conveyor section, the improvement wherein the first one of conveyor sections includes a protective cover therefore covering the top of the first one of the first conveyor sections when the first one of the conveyor sections is in an extended position from the other conveyor section.

### BRIEF DESCRIPTION OF THE DRAWINGS

A detailed description of the embodiments is provided below with reference to the following drawings, in which:

FIG. 1, is a diagram, illustrating in a side view, a typical and conventional telescopic conveyor belt system, according to an embodiment of the present invention, with the extendable frame of the conveyor belt system in a retracted position;

FIG. 2, is a diagram, illustrating in a perspective view, the telescopic conveyor belt system of FIG. 1 with the extendable frame in an extended position, according to an embodiment of the present invention;

FIG. 3, is a diagram, illustrating in perspective view, and in greater detail the conveyor of FIGS. 1 and 2 (in an extended position) incorporating the retractable cover of the present invention, according to an embodiment of the present invention;

FIG. 4 is a diagram, illustrating the conveyor of FIG. 3 with the cover in a retracted position (together with the inner conveyor also being in a retracted position), according to an embodiment of the present invention;

FIG. 5, is a diagram, illustrating the conveyor of FIGS. 3 and 4, according to an embodiment of the present invention, with the cover in a substantially retracted position;

FIG. 6, is a diagram, illustrating an enlarged detail view of a portion of the frame for mounting the retractable cover and also illustrating the cable which advances and retracts for extending the inner conveyor, according to an embodiment of the present invention;

FIG. 7, is a diagram, illustrating an enlarged view of an upper portion of the mechanism for retracting and extending the cover for the inner conveyor, according to an embodiment of the present invention; and

FIG. 8 is a diagram, illustrating an enlarged view of the portion of the frame structure for mounting the retractable cover to the upper section of the inner conveyor, according to an embodiment of the present invention.

### DETAILED DESCRIPTION OF EMBODIMENTS OF THE PRESENT INVENTION

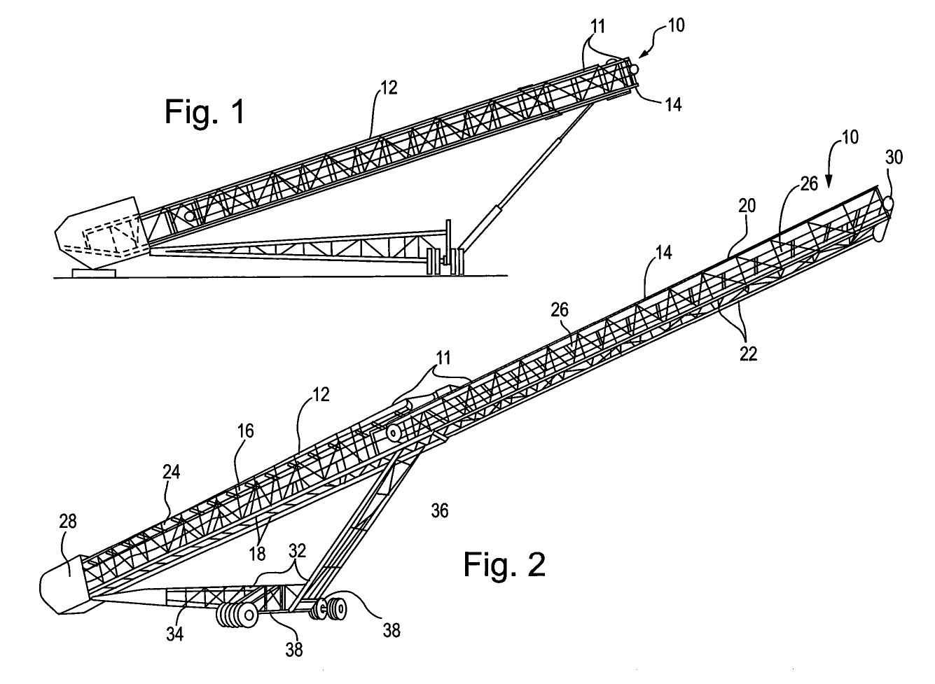

Various embodiments of the present invention will be described in detail with reference to the accompanying drawings. Referring to FIGS. 1 and 2, a telescopic conveyor belt system, indicated generally by 10, is shown in the conveyor belt system 10 includes a telescopic frame 11 which has an elongate base frame 12 and an elongate extendable frame 14. Both the base frame 12 and the extendable frame 14 have a generally rectangular cross-section, with the cross-section of the extendable frame 14 being smaller than the cross-section of the base frame 12 so that the extendable frame 14 can be received within the base frame 12. The extendable frame 14 is telescopically mounted for reciprocal movement in and out of the base frame 12. FIG. 1 illustrates the conveyor belt system 10 with the extendable frame 14 in a retracted position and FIG. 2 illustrates the conveyor belt system 10 with the extendable frame 14 in a fully extended position.

The base frame 12 and extendable frame 14 each include a pair of elongate upper support rails 16 and 20, respectively, and a pair of elongate lower support rails 18 and 22, respectively. The upper support rails 16 and the lower support rails 18 of the base frame 12 are interconnected in a conventional manner by a number of brace members, and the upper support rails 20 and the lower support rails 22 of the extendable frame 16 are also connected together by a number of brace members. It will be appreciated by those skilled in the art that the use of support rails which are interconnected by braces is conventionally used in large scale telescopic frame structures in order to maximize the strength of the frame while minimizing its weight.

The conveyor belt system 10 includes a first conveyor belt 24, which is mounted on the base frame 12, and a second conveyor belt 26, which is mounted on the extendable frame 14. As best seen in FIG. 2, the first conveyor belt 24 is mounted such that its load carrying surface is located above upper support rails 16 of the base frame 12, and the second conveyor belt 26 is mounted such that its load carrying surface is located below the upper support rails 20 of the extendable frame 14. This configuration provides the necessary clearance for retracting the extendible frame 14 within the base frame 12. Conveyor belts 24 and 26 are mounted on their respective frames for movement in a conventional manner, and when in operation serve to move a load such as aggregate from a feed end 28 of the conveyor system (located at the lower end of the base frame 12) to a discharge end 30 of the conveyor system (located at an upper end of the extendable frame 14).

The conveyor belt system 10 makes use of an actuator means known in the art for extending and retracting the extendable section 14.

The telescopic frame 11 of the conveyor belt system 10 is mounted on a support frame 32, such that telescopic frame 11 can be raised and lowered and also transported from place to place. Support frame 32 includes a horizontal frame 34, to which the base frame 12 is pivotally mounted in the vicinity of its feed end 28. A hydraulic lift frame 36 is provided for elevating and lowering the telescopic frame 11. The support frame 32 includes wheel assemblies 38 which can be rotated about the horizontal frame 34 between a use position as shown in FIGS. 1 and 2, and a transport position (not shown). In the use position, the wheel assemblies 38 extent substantially transversely from the longitudinal axis of the telescopic frame 11 and allow the conveyor belt system 10 to be radially rotated about its feed end 28. In the transport position, the wheel assemblies 38 extend parallel to the longitudinal axis of the telescopic frame 11, and permit the conveyor belt systems 10 to be towed from place to place (with the extendable frame 14 in a fully retracted position, and the telescopic frame 11 in a fully lowered position). Thus the conveyor belt system 10 is a portable, telescopic, radial conveyor belt system which can be used for a number of applications, including forming non-segregated piles of aggregate. Conveniently, the conveyor belt system 10 may also include wheels (not shown) located at its feed end 28 so that the system 10 can be moved in a lateral direction as well as longitudinally without having to raise the feed end 28 up off of its supports.

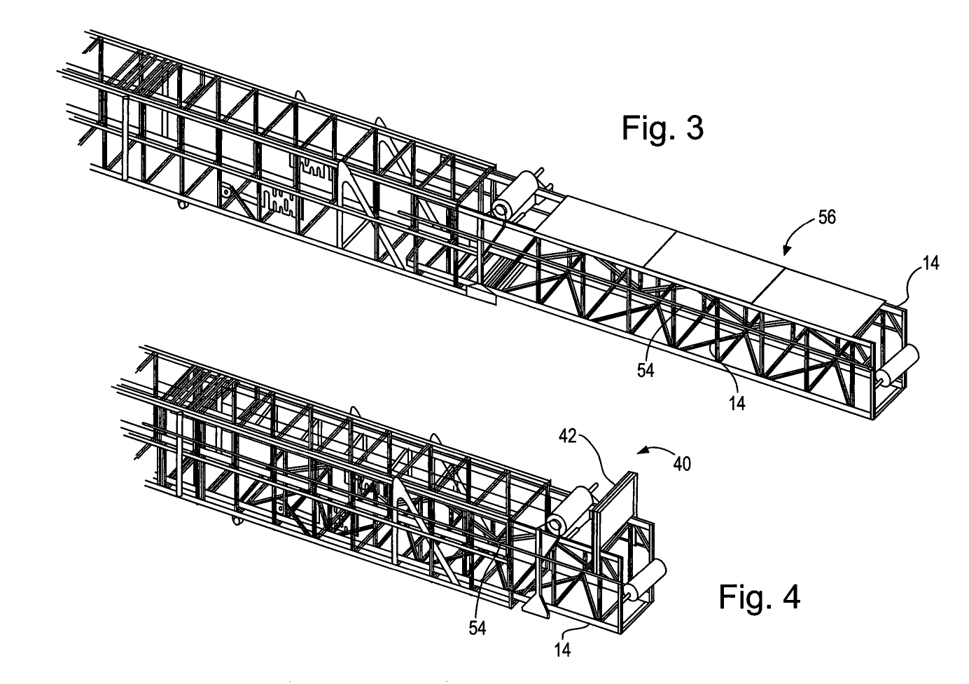

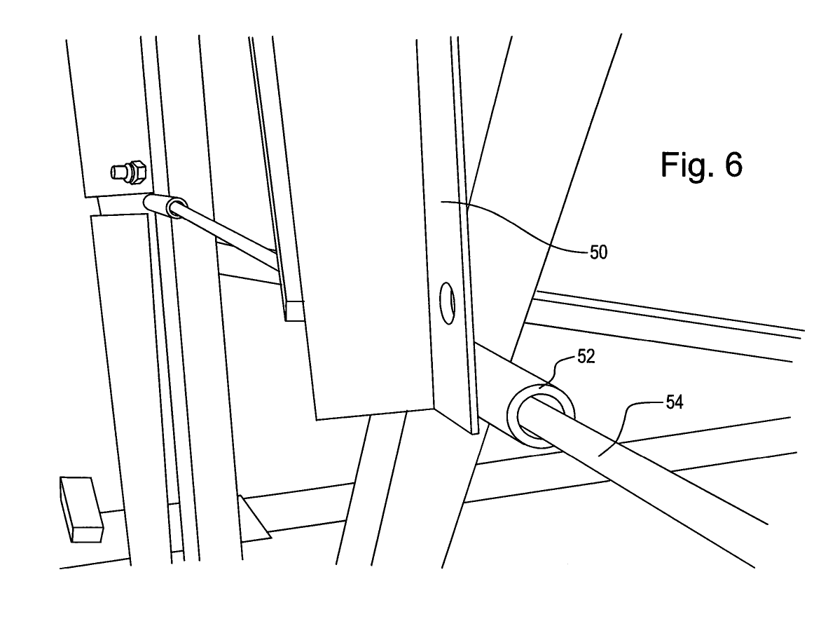

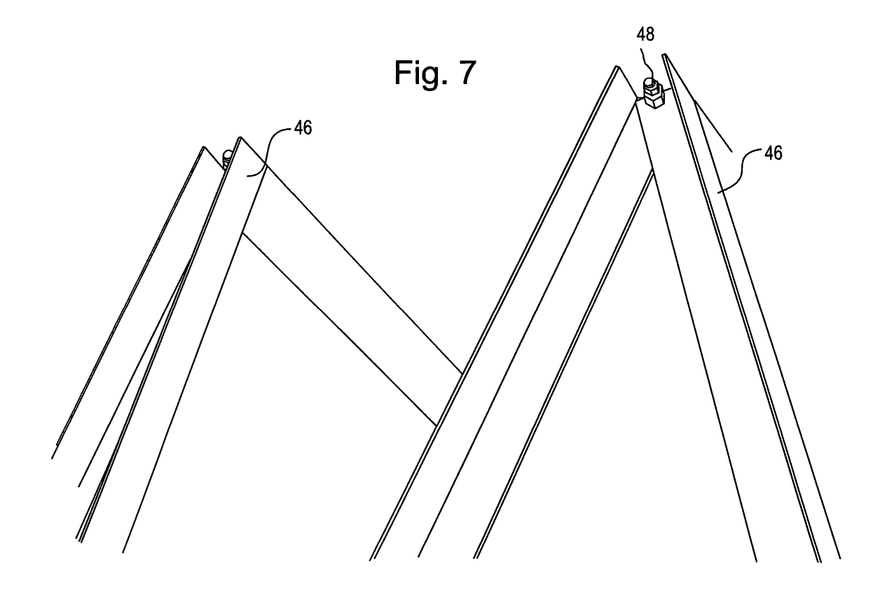

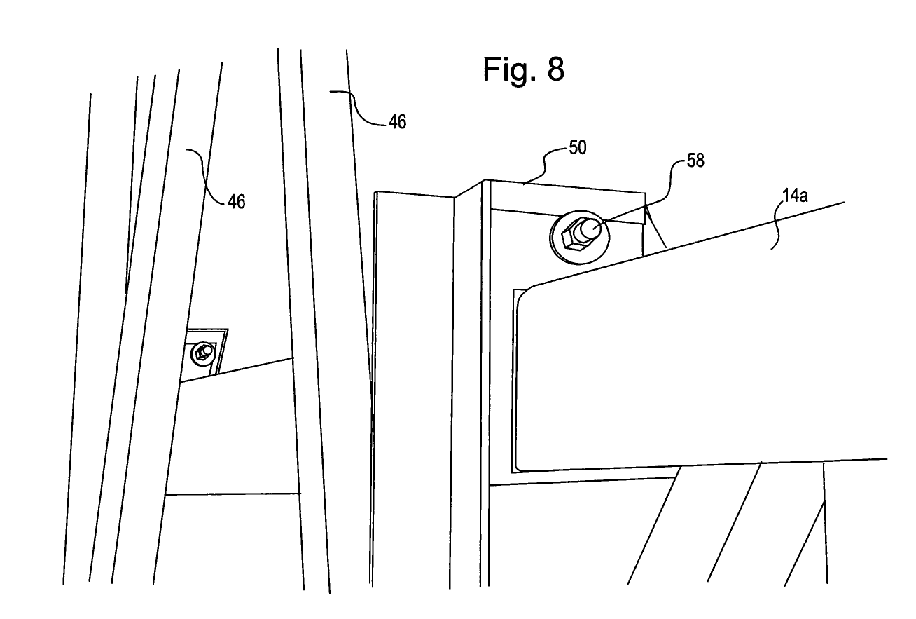

Referring now to FIGS. 3 to 8, and in particular, FIGS. 3 to 4 initially, the conveyor assembly described above with respect to FIGS. 1 and 2 is illustrated with the cover in the extended protective position (FIG. 3) and in a collapsed storage position (FIG. 4). In the storage position, the cover and mounting mechanism therefore is indicated generally by reference numeral 40 and it will be seen that there are a plurality of generally rectangular frames in juxtaposition with each other in the storage position.

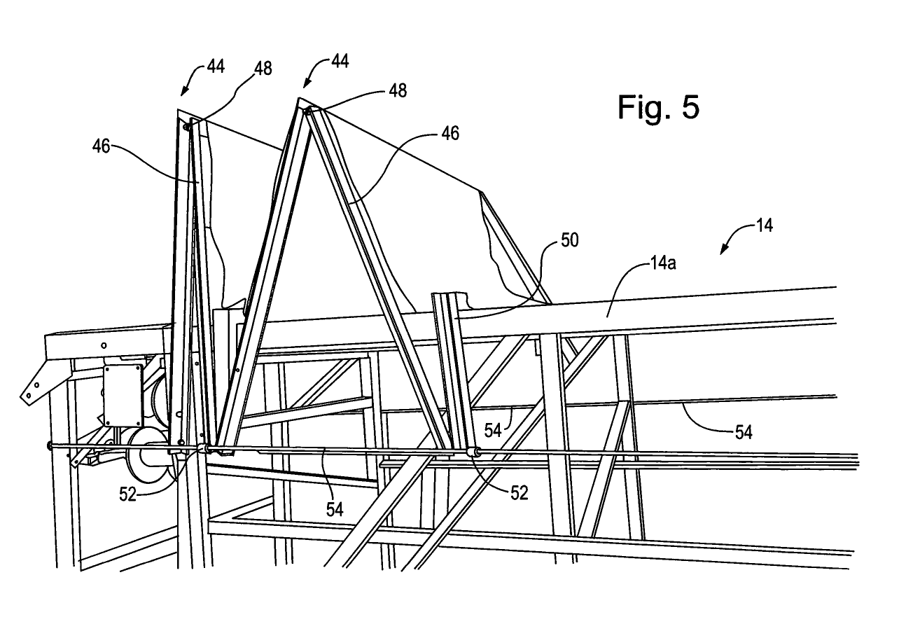

FIG. 5 illustrates the storage mechanism in greater detail and as will be seen, there are a plurality of pivotably mounted frames indicated generally by reference numeral 44 each of which includes a pair of opposed arms 46 pivotably connected at the top by means of a pivot 48 which thus permits the arms 46 to extend along the upper portion of the inner conveyor assembly 14. The arms 46, at their lower end, are connected to frame members 50 (opposed pairs on each side of the frame member 14a of the inner conveyor assembly and with each member 50 having a u-shaped top member adapted to surround the profile of the frame member 14a). In turn, the lower portion of the frame members 50, on each side of the inner conveyor assembly, are fixedly secured to a hollow tube frame member 52 which extends along either side of the inner frame assembly. Extending through the hollow tube frame members 52 is a guide cable 54 on each side of the inner conveyor assembly (similar to a handrail). The inner conveyor assembly moves into and out of operative relationship with the outer conveyor assembly by means of a winch cable travelling along the underside of the outer conveyor (not shown) according to conventional practices. This will permit the overall conveyor assembly to become a telescopic apparatus. Any suitable means (such as the cable) can be used for retracting and extending the inner conveyor assembly.

A protective cover indicated generally by reference numeral 56 is operatively associated with the upper portion of the inner conveyor assembly (see FIG. 3); this cover can be made of any suitable material depending on the use of the conveyor system. Desirably, the cover 56 is made of flexible material to permit the cover to be folded into sections or panels when in a collapsed position as shown in FIG. 4. The cover is also desirably of a single length of material. Mounting of the cover is achieved by the use of the arms 46 and as will be seen from FIG. 5 the cover, when in a folded position, has panels which are in juxtaposition with each other. Mounting of the cover onto the frame members 46 is illustrated in FIG. 8 where opposed ends of the cover, in a longitudinally direction, are bolted through bolts 58 to the upper section of the frame members 50 using suitable backing plates or the like. Thus, movement of the frame members 50 will obviously effect movement of the cover panels associated with each of the frame members 46. As shown in the drawings, the cover material is draped over opposed pairs of arms 46 with a suitable frame member extending across the width of the inner conveyor assembly (not shown). Such a frame member may be of a tubular configuration to provide a smooth surface in which the cover moves.

It will be understood by those of ordinary skill in the art that various modifications can be made to the embodiments described above, without departing from the spirit and scope of the present invention as defined by the appended claims.

What is claimed is:

1. A telescopic conveyor having at least first and second conveyor sections in which a first one of said conveyor sections is retractable and telescopes into at least one other conveyor section, the improvement wherein the said first one of conveyor sections comprises:
a protective cover therefore covering the top of said first one of said first conveyor sections when said first one of said conveyor sections is in an extended position from said other conveyor section.

2. The telescopic conveyor system as claimed in claim 1, wherein the protective cover is retractable between a use position and a storage position and said protective cover comprises a plurality of covered panels to form a continuous cover extending substantially the major length of said first conveyor section.

3. The telescopic conveyor system as claimed in claim 2, wherein said cover panels are foldable when in the storage position.

4. The telescopic conveyor system as claimed in claim 2, wherein said cover panels comprise a flexible material.

5. The telescopic conveyor system as claimed in claim 1, wherein said protective cover is mounted by movable frame sections and in which the protective cover is positioned above said first conveyor section whereby said protective cover forms a substantially continuous top cover for said conveyor section.

6. The telescopic conveyor system as claimed in claim 1, wherein said protective cover is mounted to said first conveyor section by movable frame sections capable of extending and advancing with a telescopic movement of said first conveyor section and capable of retracting into a storage position upon retraction of said first conveyor section into said at least one other conveyor section

7. The telescopic conveyor system as claimed in claim 6, wherein said frame sections comprise a plurality of spaced apart individual frame sections in which each frame section comprises a pair of opposed frame arms in which the frame arms pivotably connected to each other at one end thereof, the opposed frame members having connecting means extending between the opposed frame members and adapted to mount and support the protective cover when in a storage position.

8. The telescopic conveyor system as claimed in claim 6, wherein said movable frame sections are actuated for movement by movement of said first conveyor section when said first conveyor section is extended from a storage position within said at least one other conveyor section.

9. The telescopic conveyor system as claimed in claim 8, wherein movement of the frame sections is effected by said frame sections being operatively associated with drive means for extending said first conveyor section from storage within said at least one other frame section.

10. The telescopic conveyor system as claimed in claim 6, wherein said protective cover includes guide means for guiding said protective cover mounted by said frame members along a frame member of said first conveyor section.

11. The telescopic conveyor system as claimed in claim 1, wherein said protective cover, when retracted to a storage position, is stored in a vertical position adjacent the forward end of said first conveyor section.
